(19) United States
(12) Patent Application Publication
(10) Pub. No.: US 2021/0218904 A1
(43) Pub. Date: Jul. 15, 2021

(54) Automated apparatus to obtain images in incremental focal-distance steps using either focus ring rotation or linear translation methods

(71) Applicant: Rheal P. Turcotte, Oak Park, IL (US)

(72) Inventor: Rheal P. Turcotte, Oak Park, IL (US)

(21) Appl. No.: 16/738,857

(22) Filed: Jan. 9, 2020

(51) Int. Cl. H04N 5/232; H04N 5/225; G02B 7/09; G03B 13/36

(52) U.S. Cl. CPC H04N 5/232133; H04N 5/232125; H04N 5/23216; G03B 13/36; H04N 5/2253; G02B 7/09; H04N 5/2254

(57) ABSTRACT

Because of modern computers and digital cameras, it is now possible to take a series of photographs at incremental focus distances and then combine all of these into a single composite photograph. There are three ways to acquire the stepwise images, either manually or automatically. This invention allows all three methods to be executed using a single automated apparatus by using different means of positioning/moving the camera or lens. This includes external rotation of the focus ring (1), or linearly moving the camera and lens together (2), or moving just the camera (3a), or moving just the lens (3b) in highly controlled steps, thus allowing rapid collection of many images, each at incremental focus depths into the subject. These “stacks” can then be processed using any of several commercial software packages to combine all the images into a single high-resolution composite image.

### RELATED APPLICATIONS

US Provisional filing—Application No. 62/922,425 filed Aug. 8, 2019—Confirmation number 3184, mailed Aug. 23, 2019

Related patent submission: Method to automatically obtain images in incremental focal-distance steps using any camera/lens having a rotatable focus ring (R. P. Turcotte). Filed Jan. 9, 2020.

NA

NA

NA.

NA

### BACKGROUND OF THE INVENTION

### 1. Field of Invention

This invention is in the broad field of imaging/photography and more specifically is for automated image capture in sequential focus-distance steps using still or video cameras.

### 2. Description of Related Art

This invention provides improved means to obtain photographs of any subject, ranging from very small insects to distant landscapes with the entire image in complete focus. In the past, such extended depth of field (DOF) photographs were obtained using so-called field cameras (4″×5″ film) using very small apertures and with a bellows attachment, tilting the lens relative to the plane of the film to maximize DOF.

Modern digital cameras and special attachments also allow tilting the lens and most “Macro” photographers use small apertures to achieve high DOF. Because of modern computers and digital cameras, it is now possible to take a series of photographs at incremental focus distance and then combine all of these (perhaps hundreds of shots) into a single composite having very high sharpness/resolution throughout the entire image. There are several ways to acquire the stepwise images, either manually or automatically:
Rotate the focus barrel (internally or externally) (Method 1)
Move the camera and lens together on a linear rail (Method 2)
Move just the lens or just the camera (Method 3)

For the past decade or so, Methods 2 (mainly) and 3 have been used extensively by photographers interested in high resolution images. Method 2 is accomplished for small objects (Macro-photography) by use of a manual rail or a linear rail and stepper motor having a lead screw and moving platform, allowing steps in distance as small as 0.01 mm. This method however is limited to subjects not much larger (in terms of depth) than the length of the rail, typically 10-20 cm. A few high-end cameras with certain auto-focus lenses are now able to take multiple images as the camera automatically adjusts the focal distance. While these cameras work, they do not allow full control of the process and require auto-focus features. Our invention will work with any camera and any lens. Of course the lens must have a focus ring for Method 1 and the camera must have a shutter that can be activated electronically for full automation.

Method 1 can be accomplished manually and there are a few approaches offered commercially to improve the ease of manual changes. One company (Wemacro) offers a means to automatically rotate the focus knob of a microscope to take in-depth images of microscopic objects. Method 1 can now also be accomplished with another commercial “add-on” product—Helicon FB Tube is an extension tube with integrated electronic microcontroller designed to enable automated focus bracketing in single or continuous shooting modes. The Helicon FB Tube automatically shifts the focus by one step with each shot thus producing any desired stack of images for computer processing to obtain the final image. This device currently (2019) only works on selected Nikon and Canon cameras using selected (auto-focus) lenses.

A second patent submitted and entitled “Method to automatically obtain images in incremental focal-distance steps using any camera with lens having a rotatable focus ring” (R. P. Turcotte) should be reviewed for additional details concerning Method (1) as configured here, though the key attributes are also provided herein.

Technical considerations—before further describing this invention, it is useful to recognize some basic features and constraints regarding camera lens in general that lead to its design and implementation.

First, before focus stacking images using computers became possible and even now, it is common practice to use very small apertures (e.g. f32) to maximize the depth of field (DOF). When this is done, because of diffraction effects, some blurring occurs. It is commonly understood the sharpest images are obtained with the lens a few stops less than the wide-open aperture for any given lens (e.g. f5.6 or f8). Mid-range apertures up to about f20 may also show little diffraction related blurring for some lens. In any case, since focus stacking removes the DOF constraint, optimum lens settings can be used to deliver the sharpest image, affecting only the number of images required in the stack. The number and size of steps in terms of distance is usually chosen to be about ½ the DOF at the desired camera-subject distance in order to overlap the pixel data. This often leads to stacks of 10-100, or more images.

It has been suggested in various forums that all three of the methods identified above result in changes during shooting that must be accounted for with the software compilation/rendering as the many images are transformed into a final image. Some believe moving just the camera, not the lens will be better than moving both the camera and lens together and others believe the differences should be relatively small. It is also well understood that the current software packages are not yet perfected and for example have trouble rendering images of subjects having sharp edges where halo effects often occur. These problems can be largely corrected by using “clone” tools to extract information from a single image, or a few images in the stack and replacing the halo region in the final image with the correct view. It is not understood yet whether the three different image acquisition methods are all equally well processed by the stacking software or whether one is preferred and why. That would depend on details of the algorithms used which are likely different in different software approaches. And of course, the software at this point has likely been written assuming a linear rail approach is used or secondarily, hand rotation of the focus ring is used. In the future, software may be developed taking advantage of the specific way the images are collected, because while it all is governed by the same physics/mathematics in the end, the data may be collected in ways to simplify, or inadvertently exacerbate the rendering process. At this time, the software (Helicon) alerts the user if the step sizes are not uniform or if the lighting conditions vary much within the stack as a problem, but consequences are not clearly defined. In any case, our work suggests the focus ring Method (1) may be superior and we also expect moving just the camera or just the lens will also be better than moving the camera and lens together on a linear rail (Method 2, which is the primary current method used). The next section describes a reason why Method 2 may not be the best choice.

Second, a simple version of the lens maker equation is given for a thin lens approximation by

1/q+1/p=1/f

and it can be shown that magnification is given by

m=f/(p−f)

where q is the distance from the lens to the sensor, p is the distance from the lens to the subject, and f is the focal length of the lens. This explains the magnification differences among lens of different focal length (f).

Note that m=1 (expressed in photography as 1:1) when p=f. This is the reason why macrophotography is best accomplished “close-up”, near the shortest focal point possible, wherein the subject just fills the sensor area. For modern, complex macro-lenses, the point at which m=1:1 is typically not when p=f but is closer to when p=3f.

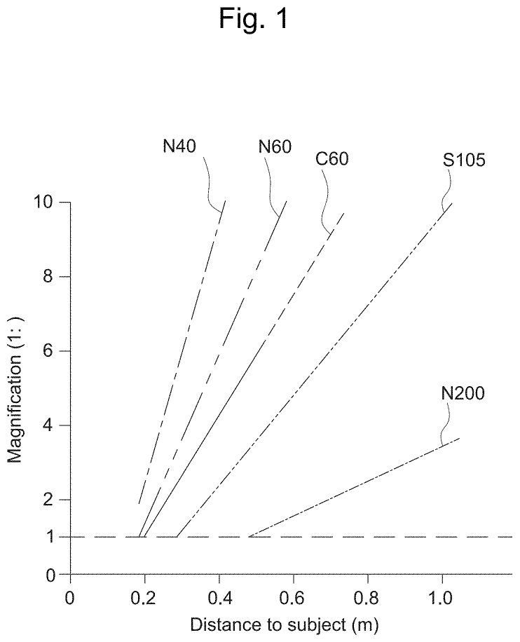

FIG. 1 shows the magnification changes that occur with various lens by plotting the magnification ratio (1:x) where 1:1 occurs at or the nearest distance the lens can be in focus. This is the optimum condition for macro photography since the number of pixels is maximized. For example, at a magnification 1:4, only ¼ of the pixels are used. As shown in the figure, the change in magnification is quite large and occurs most rapidly with smaller focal length lens (like 40 mm) compared to a telephoto lens (like 200 mm).

Table 1 shows what this means in terms of sensor utilization for three lens, considering a subject that is 100 mm in depth. On a linear rail, the camera and lens must move about that distance (somewhat less because of DOF) to obtain images from the front to the back portion. In table 1 the initial lens position for 1:1 magnification is focused at the back of the subject and the resulting magnification change is after moving 100 mm away (d+) to focus on the front. Note again, at 1:1, the sensor use is near 100% and in this example is achieved only at the back of the image. It should be noted, for this comparison assumed the 40 mm lens could achieve 1:1 magnification, though this specific lens could only reach 1:2.

TABLE 1

| Lens | 1:1 distance | | Mag. at | Sensor |
|---|---|---|---|---|
| (mm) | (m) | d + (m) | d + (1:) | use (%) |
| 40 | 0.16 | 0.26 | 5.2 | 60 |
| 85 | 0.28 | 0.38 | 2.5 | 70 |
| 200 | 0.49 | 0.59 | 1.6 | 82 |

The table shows by using the linear rail Method (2) that not only does the magnification change significantly, but the pixel density on average is reduced by 18 to 40%, meaning the magnification correction in the stacking process is both large and the ultimate resolution is reduced. Note the changes are much smaller for the 200 mm lens, making it attractive for any focus stacking approach.

In comparing Method 2 to others, using the focus ring rotation Method (1), or using Method (3), by moving just the camera, or just the lens to achieve front edge and back edge focus, the lens to sensor distance (q) changes only a few mm and the lens to subject distance changes little or not at all. This means the magnification changes are only a few percent and the average sensor utilization is maximized near 98%. In our work, we have verified method 1 indeed shows less than 2% change in magnification and the linear rail method shows a magnification change greater than 25% for the 200 mm lens.

It turns out that the commercial software available (Helicon and probably others) does a good job regardless of the magnification corrections, however for macro-photography (and perhaps other types, to be determined) we do see improved resolution for the focus ring method compared to the linear rail—method 2, using the same camera, lens, lighting, etc.

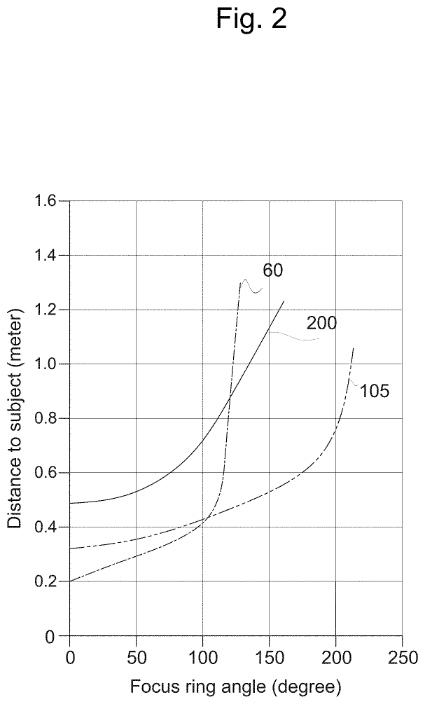

Third, although the linear rail method is precisely linear in distance/step, the focus ring on any lens is quite non-linear regarding focus distance, as displayed in FIG. 2, for three different focal length lens. While every lens is somewhat different, they have a common form, with a relatively linear distance/rotation angle dependence at short distances (<1 m) reaching a knee at (1-2 m) and then rapidly rising at long distances. For example, the focus ring for the 105 mm lens rotates about 150 degrees in going from 0.3 m to 0.4 m, and another 100 degrees or so to go from 1 to 20 m. This non-linearity is easily seen by the markings on most prime lens.

This behavior is important for the lead-screw embodiment used in this invention for focus ring rotation, because for practical mechanical reasons, it does have a limit of about 120 degrees during any one stack collection. Thus, in order to cover the entire depth range from the nearest point out to infinity (about 250 degrees rotation), it may be necessary to do two series of photo collection. It would be better to do so anyway, because many fewer shots are needed at long distances since the DOF increases dramatically in that range. Thus it can be better for landscape or some product photography to use two series of image collection, one for <1 m and a second from 1 m to near the so-called hyperfocal distance, discussed next.

Fourth, because of the large increase in DOF with distance from the subject it is possible to increase apparent in-depth clarity for the subject of interest by simply increasing the distance. In fact, there is a point at which the focus is “acceptably sharp” from that point to infinity, called the hyperfocal distance. This distance is a strong function of the lens focal length, being 216 meters for a 200 mm lens, 39 meters for an 85 mm lens and 9 meters for a 40 mm lens. This becomes very important in (for example) landscape photography where using an 85 mm lens, one can take a picture with the focus made to be sharp at 39 meters and everything from that point out to infinity will be in focus. Because of the large DOF at that distance, the image will be in focus from near 19 m to infinity. In this example, the method of focus stacking can best be used by taking two series of images, one from <1 m and one from 1 m to 40 meters. It is also useful for landscape photography to use smaller apertures to increase the DOF, but not so small as to incur diffraction related blurring.

If we consider images acquired in close proximity, especially for small subjects photographed from cm's or tens of cm, the same principles apply and influence what distance is best to obtain the desired stack, bearing in mind the strong loss of resolution (pixel density) and magnification changes that occur with increasing distance. Of course, given the sensor area is only about 25×40 mm, or smaller, subjects larger than that can only be imaged completely by moving back from the 1:1 distance. In any case, macro-photographers usually work “close-up” and may employ extension tubes or bellows extension of a lens or even use microscope lenses to magnify the subject. Even with these extensions, it is still possible to use any of the three methods to obtain the desired stack of images in small distance increments.

References cited
USA Patents

| | | | |
|---|---|---|---|
| U.S. Pat. No. 7,616,877 | B2 | November 2009 | Zamowski . . . |
| U.S. Pat. No. 8,009,371 | B2 | August 2011 | Sue . . . |
| U.S. Pat. No. 8,287,195 | B2 | October 2012 | DeZeeuw . . . |
| U.S. Pat. No. 8,305,453 | B2 | November 2012 | Terauchi |
| U.S. Pat. No. 8,493,461 | B2 | July 2013 | Baker . . . |
| U.S. Pat. No. 8,532,477 | B2 | September 2013 | Kazami |
| U.S. Pat. No. 8,570,396 | B2 | October 2013 | Rapaport |
| U.S. Pat. No. 9,016,960 | B2 | April 2015 | Gutierrez |
| U.S. Pat. No. 9,094,611 | B2 | July 2015 | Kennedy . . . |
| U.S. Pat. No. 9,584,708 | B2 | February 2017 | Matsuzawa . . . |
| U.S. Pat. No. 10/154,203 | B2 | December 2018 | Ferren . . . |
| U.S. Pat. No. 10/264,171 | B2 | April 2016 | Ikeda . . . |
| U.S. Pat. No. 10/365,500 | B2 | July 2019 | Hu . . . |
| U.S. Pat. No. 10/367,989 | B2 | July 2019 | Tanaka . . . |
| U.S. Pat. No. 10/368,015 | B2 | July 2019 | Choe . . . |
| US2019/0174054 | A1 | June 2019 | Srivastava . . . |
| US2019/0191145 | A1 | July 2019 | Chang . . . |
| US2019/0230289 | A1 | July 2019 | Flanigan . . . |
| US 2019/0238737 | A1 | August 2019 | Matsuno . . . |
| US 2019/0238757 | A1 | August 2019 | Sugaya . . . |
| US2019/0238781 | A1 | August 2019 | Kobayashi . . . |

### OTHER PUBLICATIONS

Johnson, Jr. Charles S. Science for the Curious Photographer. Natick, Mass.: A. K. Peters, Ltd. 2010.
Taylor, David. Mastering Macro Photography. East Sussex, UK: Ammonite Press. 2017.
Cremona, Julian. Beyond Extreme Close-Up Photography. Wiltshire, UK. The Crowood Press, Ltd. 2018.
Linear rail-Cognisys. https://www.cognisys-inc.com
Linear rail-WeMacro. https://wemacro.com
Software/hardware-Helios. https://heliconsoft.com
Software-Zerene Stacker. https://zerenesystems.com
General Photography/DOF www.bobatkins.com

### BRIEF SUMMARY OF THE INVENTION

As discussed earlier, this invention allows all three methods of acquiring images in small focus distance steps using the same apparatus, but in different configurations. For the past decade or longer (manually), method 2 has been the primary method used by photographers and scientists interested in high resolution images produced through the stacking process. Because of the factors discussed above, and continued development of software to execute focus stacking, it remains uncertain whether one method or another will be found to be “best” which is the reason for creation of the apparatus embodied in this invention, allowing work with all three methods.

It is possible using a commercial stepper motor/linear rail/lead-screw device positioned below and at 90 degrees in relation to the camera/lens to effect rotation of the focus ring as by Method 1. This involves magnetically coupling to a rigid tab extending down from the ring in such a way that the moving platform on the rail causes rotation of the focus ring. This arrangement can be configured by mounting the camera and lens on one tripod and the linear rail system on a second tripod. It can also be accomplished by creating a framework having an upper platform and a lower platform, all mounted on the same tripod. The linear rail system could also be used directly to execute Method 2 as already commonly done, and with appropriate connection means and using bellows to couple the lens and camera, Method 3 could be accomplished. This arrangement could thus achieve all three methods but would be cumbersome and not very portable.

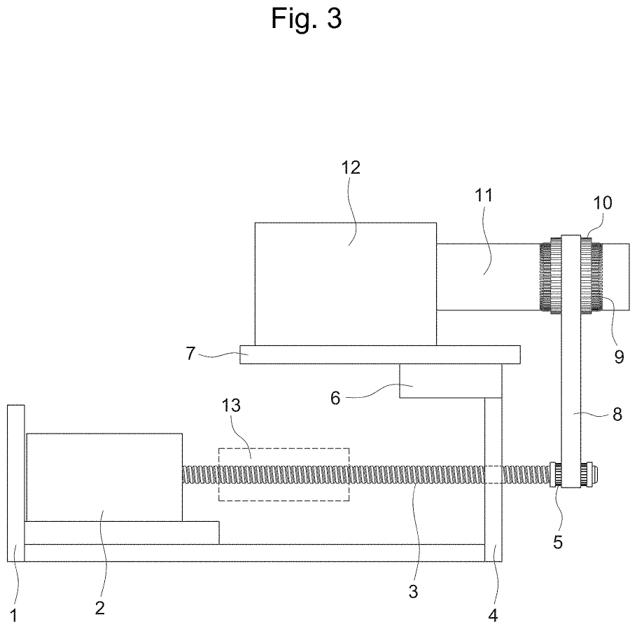

It is also possible as described further in another patent submission (Turcotte) to mount the camera/lens above and on the end of a modified commercial stepper motor/linear rail/lead-screw device in such a way that by extending the lead screw out beyond the end, a pulley gear can be attached to it. By then adding a gear band to the focus ring, a pulley-gear-band can couple the drive gear below to the focus ring above, allowing the stepper motor to control rotation of the focus ring. In this configuration, the pitch of the lead screw has no effect on resolution as the screw is functioning simply as an extension of the motor axle. We will call this configuration Structure A (see FIG. 3). This commercial rail system can then also be then used to execute both Method 2 and Method 3 by using different placement/connections for the camera and lens.

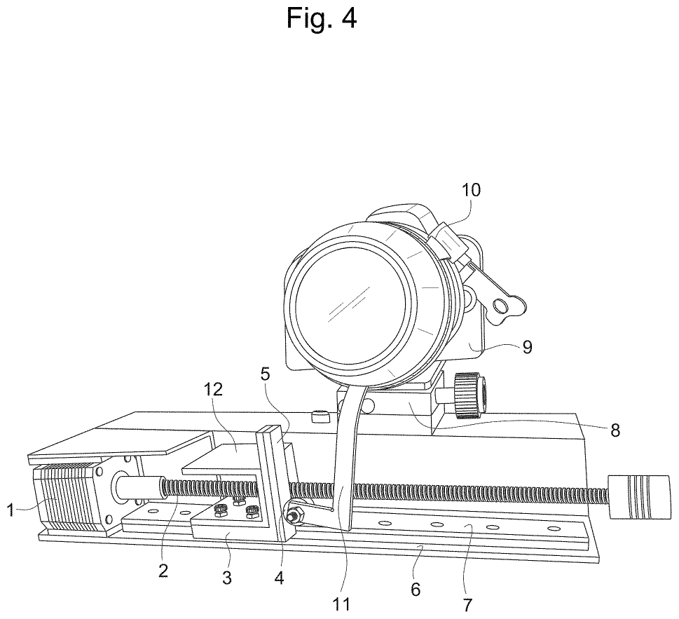

The preferred embodiment of this invention employs a linear rail and hardware to support a stepper motor/lead screw mechanism on the bottom platform of a Z-channel support structure. Though we use the term Z-structure, it is really two horizontal platforms, off-set, and connected by a vertical plate. Using this structure, the camera and lens can be attached in different ways to execute all three Methods and will be referred to here as Structure B and is favored over Structure A. The apparatus is tripod mounted but is very portable, being about (30×10×10) cm in size in a preferred embodiment, though both smaller and larger configurations are easily possible. The preferred size (including the motor and rail) weighs less than 2 kg (aluminum hardware), and is battery powered. It could be made even lighter by using carbon fiber composites for most of the hardware and by using a smaller stepper motor. The invention uses the same basic hardware to execute any of three possible methods (see FIGS. 4-7) to acquire the images, differing mainly in the way the camera and lens are mounted, in all cases involving use of quick-release clamps to facilitate switching to any of the three methods.

### BRIEF DESCRIPTIONS OF THE DRAWINGS

The drawings describing the invention in its's various forms and related information are as follows:

1. The Magnification factor (1:x) is plotted for various focal length lenses and manufacturers as a function of distance to the subject showing larger changes the smaller the focal distance of the lens

2. The focus ring angle for 60 mm, 105 mm and 200 mm lens is plotted as a function of distance to the subject, showing strong non-linearity for all lenses, with the highest distance/angle ratio being at short distances, <1 m.

3. This figure shows how a commercial motor-driven, linear rail can be adapted to execute focus ring rotation (Method 1) by extending the leadscrew and using a pulley gear-band to connect the pulley gear at the end of the leadscrew to the focus ring barrel above.

4. This figure shows a Z-channel mounted motor/lead screw/moving plate (magnet) method to rotate the focus ring (Method 1) by means of a rigid arm extending down from the focus ring.

5. This figure shows a block diagram for creating linear translation of the camera and lens together (Method 2)

6. This figure shows a Z-channel mounted motor/lead screw/moving platform/magnet confined to a rail in order to move just the camera, with the lens fixed in place (Method 3)

7. This figure shows a Z-channel mounted motor/lead screw/moving platform/magnet confined to a rail in order to move just the lens, with the camera fixed in place (Method 3)

8. This figure shows a Block Diagram for the electronic system.

### DETAILED DESCRIPTION OF THE INVENTION

Before discussing the figures in detail, the three methods are first described in general, especially to explain resolution characteristics which vary by a factor of 3 or more, but which are all better than required for most applications.

Method 1 Focus Ring Rotation

In one configuration (A), a commercial motor/lead screw/linear rail system is adapted by extending the lead screw out from the system end plate, adding a drive gear to the end of the screw and also mounting the camera/lens on top of the end plate in such a way that a gear band on the focus ring aligns with the drive gear below and thereby, through use of a pulley gear band allows motor axle rotation to rotate the focus ring. Note in this use, that the lead screw pitch as no role in performance but is just an extension of the motor axle. (See FIG. 3). Using a second configuration (B), the camera and lens are placed at 90 degrees to the direction of the motorized lead screw. The camera is paced on top of a Z channel support structure while the motor and lead screw are mounted below, such that a moving nut/vertical plate passes below.

Using magnetic coupling to a rigid arm extending down from the focus ring, it can be caused to rotate. The advantage of this method over configuration (A) is that the sensitivity/resolution in terms of angular rotation is about three time better for (B) because of the different geometry involved and because the pitch of the lead screw is now an important factor. (See FIG. 4).

The means of attachment of the camera and lens to execute Method 2 or Method 3 is the same whether using configuration (A) or (B), hence the step size resolution is the same.

Method 2—Linear Translation of the Camera and Lens

In this method, the camera and lens are mounted directly on the moving platform driven by the stepper motor/leadscrew/rail mechanism as already provided by commercial systems (Cognisys, Wemacro).

Method 3—Linear Translation of Just the Lens, or Just the Camera.

In this method, instead of attaching the camera and lens together to the moving platform, the lens and camera are instead separated by a bellows which allows the two components to move independently. Either the camera or the lens can be mounted on the moving platform, the other being held fixed by the structure/base.

Regarding sensitivity, of the three methods, barrel rotation (Method 1) provides smaller step size capability and reduced magnification effects compared to both Method 2 and Method 3, but all methods provide more than adequate performance. Using Helicon software for the image stacking process, we do observe improved clarity/resolution in final images using Method 1, compared to Method 2 and we also expect Method 3 to be better than Method 2 when the lens is held fixed and the camera is moved to change the focal distance. Which of the methods is “best” may ultimately be determined by changes in the focus stacking software to accommodate one image collection method better than the others. Note that the appropriate step size in terms of focal distance change is mainly determined by the depth of field (DOF) at the desired working distance. If imaging through microscopic lens, the DOF is often well less than 0.1 mm. For other lens with large apertures used to obtain the sharpest focus, the DOF can be 1 mm or so. Since it is desirable to overlap in-focus regions in the stack, it is common practice to use ½ DOF as a criteria for selecting step size. Having said that, and disregarding the special situation of microscope lens, it is clear the depth resolution of 0.01 mm will be adequate for most work and in our experience, 0.1 mm step size is often enough. All three methods and the various embodiments of this invention achieve smaller step sizes than needed. The minimum for Methods 2 and 3 is 0.01 mm. Method 1, using configuration (B) offers the smallest step size by virtue of the leadscrew mechanical advantage, coupled to the ×3 effect of using a rigid arm extension from the focus ring to affect its rotation, being about 0.003 mm in terms of focal distance change. If needed, smaller step sizes can be obtained by using a finer leadscrew pitch. The sizes given here refer to a screw with 1 mm pitch.

The relevant figures for each method are now described as follows. Each figure has details labeled by text labels or numerically and will be referred to as 1.1, 1.2, . . . 2.1, 2.2 . . . Etc.

FIG. 1 shows the magnification changes as a function of distance for several lens demonstrating the strong dependence for short focal distance lens, being a factor of 10 for the 40 mm lens from 0.2 m (shortest distance possible) to just 0.4 m (0.2 m total). The progression is very regular going from 40 mm to 200 mm. At 200 mm the magnification change is only about ×3 while going from 1 m to 0.5 m (0.5 m total) The straight lines come from the simple expression derived through optical physics and shown earlier. Magnification is directly proportional to the lens focal length (f) and inversely proportional to the distance to the subject (p).

FIG. 2 shows the relation for Method 1 of the focal ring angle to distance from the subject for three examples; Sigma-105 mm, Nikon-200 mm and Canon-60 mm lens. We show these in part to demonstrate that different lens and manufacturers do have somewhat different characteristics, but have a common feature in having a much larger focus ring change at short distances (<1 m), a knee at around 1 m and have a relatively smaller angular change at distance >1 m. Both regions are thus covered by angular changes of about 100-150 degrees each. In our experience, at short distance to the subject we often need 10 to 50-degree rotation for macro photography but smaller changes are needed at longer distances used for example in product imaging and smaller yet for landscape photography.

FIG. 3 Commercial motor-driven, linear rail adapted to execute focus ring rotation This figure provides a block diagram showing how a commercial motor driven linear rail can be adapted to execute Method 1 (Structure A) by positioning the camera/lens in such a way that an extension of the lead screw, through a pulley-gear is able to rotate the focus ring. In this figure, the commercial rail system is shown as a side view and is confined by a base and two end plates (3.1, 3.4). The moving platform (3.13) normally used to move mounted objects horizontally can be either ignored or removed as it is not used in this adaptation. Normally, the lead screw (3.3) does not extend beyond the end plate (3.4), but by using a longer lead screw, it can be modified such that the lead screw does extend out beyond the frame end. A small diameter pulley gear (3.5) can be attached directly to the lead screw end as shown. This drive gear (3.5) interfaces with a pulley gear band (3.8) which in turn interfaces to a gear band (3.10) that is attached to the focus ring (3.9). Though not shown here, a freewheeling pulley gear can also be added to the end plate (3.4) in such a way as to provide a tensioning mechanism to the pulley gear band (3.8). As shown, the camera (3.12) and lens (3.11) are mounted on a quick release plate (3.7). The plate is held by the clamp (3.6) which is attached directly to the end plate (3.4). The camera and lens can be easily moved to position the focus ring gear band (3.10) directly above the drive gear (4.5) below. Note that the pitch of the lead screw has no impact on the sensitivity as it is merely an extension of the motor drive axle in this use.

FIG. 4 is a drawing of the “all-in-one” apparatus capable of executing all three Methods (1,2,3) and in this embodiment configured to execute Method 1 in which the focus ring is rotated to vary the focal distance, while the camera and lens remain in place. In this case, the camera/lens (4.9) is mounted to the top surface via a quick connect clamp (4.8). A clamp on the focus ring (4.10) secures an L-shaped tab (4.11) extending down to near the lower horizonal surface (4.6). The stepper motor (4.1) and linear rail (4.7) are attached to the lower surface (4.6). A moving platform (4.3) rides on the rail, confined by ball bearings to grooves on each side of the rail (4.7). The stepper motor (4.1) turns a lead screw (4.2). A nut on the lead screw is attached to the moving platform via a U-shaped structure (4.12), thus restraining it from rotation and forcing horizontal movement of the platform and attached bar magnet (4.5). The bar magnet connects by magnetic force to the roller bearing (4.4) attached to the lower leg of the rigid arm (4.11). As the magnet moves horizontally, the focus ring rotates in either clockwise or counterclockwise direction depending on the direction of the moving platform.

Note that by removing the bar magnet and its backing plate required for Method 1, the top surface of the U-shaped structure (4.12) riding on the linear rail platform (4.3) becomes available to execute either Method 2 or Method 3.

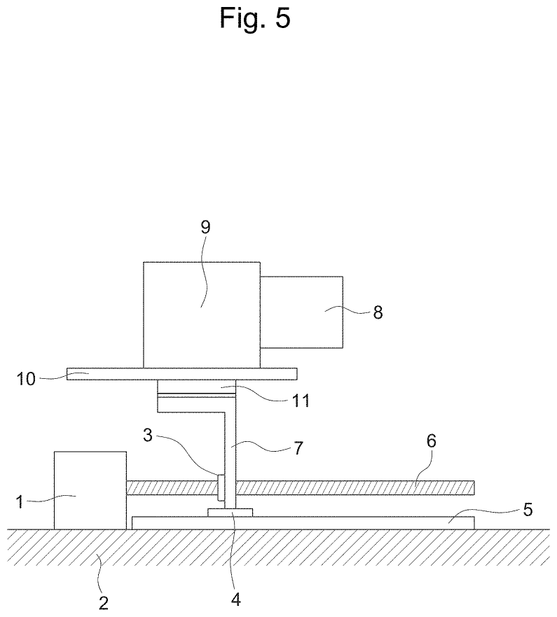

FIG. 5 shows a block diagram for Method 2, where the camera and lens are moved together on a horizonal plate (5-10). In this case the camera (5.9) and lens (5.8) are connected to a plate (5.10), held by a quick-release clamp (5.11), which is itself connected to a rigid, inverted L-shaped arm/platform (5.7). In the previous FIG. 4), the U-shaped platform/arm (4.12) serves the identical function depicted here as element (5.7). This arm is mounted on a moving platform (5.4). The platform keeps the nut from rotating, thus forcing linear movement in the horizonal direction. The platform contains small bearings that are confined to grooves on either side of the steel rail (5.5). The nut (5.3) is moved by rotation of a 1 mm pitch lead screw (5.6), which is driven by a Nema 17, 2A stepper motor (5.1). The motor (5.1) and rail (5.5) are mounted to the bottom surface of the Z-shaped channel (5.2).

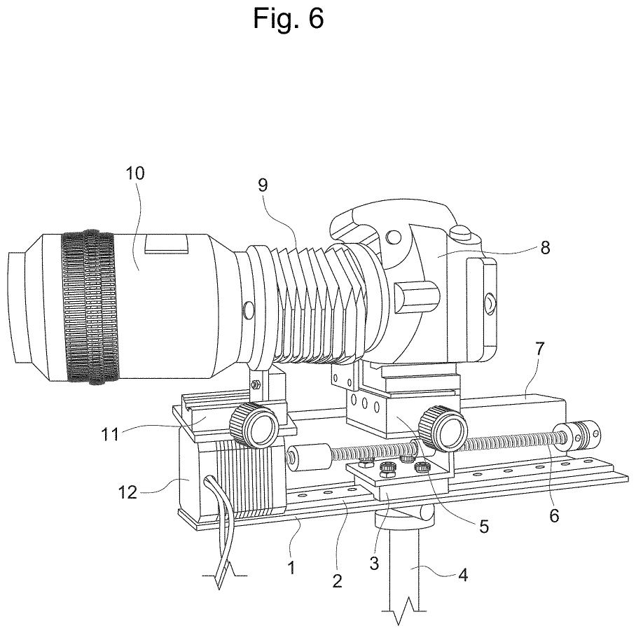

FIG. 6 is a detailed drawing for configuring Method 3, wherein the lens is fixed in place and the camera is attached to the moving platform. The lens (6.10 is attached to a quick release clamp (6.11) which in turn is connected to the top horizontal portion of the support structure (6.7). The support structure is mounted on a tripod (6.4) at the bottom horizontal portion of the structure (6.1). The lens (6.10) is attached to the camera (6.8) with a flexible bellows (6.9) such that the lens remains fixed, but the camera can move horizontally. To achieve this, the camera is mounted to a quick release clamp (6.5) which is itself attached to a moving platform (6.3). The platform is moved horizontally by means of a stepper motor (6.12) that turns a lead screw (6.6) and which in turn causes a nut to move horizontally because the nut is restrained from rotating by attachment to the moving platform (6.3). The moving platform is restrained to a rail (6.2) via ball-bearings attached to the platform and which are also confined to grooves on each side of the rail. The motor (6.12) and rail (6.2) are mounted to the lower portion of the support structure (6.1).

If instead of attaching the lens to the solid structure as shown here, the bellows (6.9) can be removed and the lens (6.10) can be attached directly to the camera. This then is the configuration needed to execute Method 2, where the camera and lens are moved together to change the focal distance.

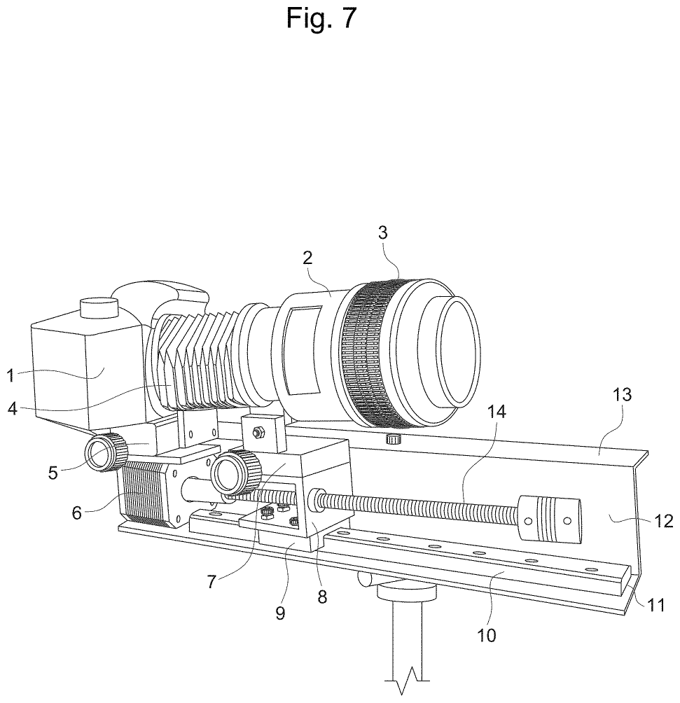

FIG. 7 is a detailed drawing for Method 3 wherein the camera is fixed in place and the lens is attached to the moving platform. The camera (7.1) is attached to a quick release clamp (7.5) which in turn is connected to the top horizontal portion of the support structure (7.13). The support structure is mounted on a tripod at the bottom horizontal portion of the structure (7.11). The lens (7.2) is attached to the camera (7.1) with a flexible bellows (7.4) such that the camera remains fixed, but the lens can move horizontally. To achieve this, the lens is mounted to a quick release clamp (7.7) which is itself attached to a moving platform (7.8, 7.9). The platform is moved horizontally by means of a stepper motor (7.6) that turns a lead screw (7.14) and which in turn causes a nut to move horizontally because the nut is restrained from rotating by attachment to a U-shaped support (7.8) which in turn is connected to the moving platform (7.9). The moving platform is restrained to a rail (7.10) via ball-bearings attached to the platform and which are also confined to grooves on each side of the rail. The motor (7.6) and rail (7.10) are mounted to the lower portion of the support structure (7.11). Note the focus ring (7.3) is not rotated in this method but the focal distance is changed by moving the entire lens (7.2) relative to the camera (7.1).

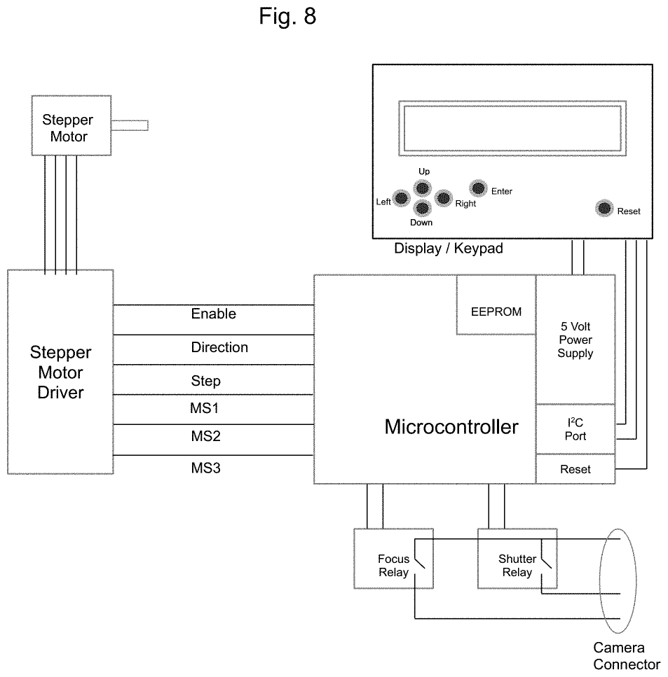

FIG. 8. shows a block diagram for the electronic control system. More details concerning it are provided in another patent submission titled “Method and hardware to automatically obtain images in incremental focal-distance steps using any camera/lens having a rotatable focus ring”. The control system can manage all three methods of operation described in this invention and the block diagram provides key elements of its functions.

As shown in the labels in this figure, the controller includes an embedded microcontroller board and is connected to a stepper motor control integrated circuit (IC), a liquid crystal display (LCD) board with keypad switches, and relays for camera shutter activation. One of many possible microcontrollers that could be used is the Microchip Atmega328P with integrated RAM, Flash and EEPROM memories.

The motor control IC (Allegro A4988) accepts digital input signals (digital outputs from the microcontroller) for:

| | |
|---|---|
| Enable | (supply power to stepper motor coils) |
| Step | (move motor one increment) |
| Motor Direction | (forward or reverse) |
| Step Resolution | (amount of each motor movement increment, set using |
| | MS1, MS2, MS3 ([Micro Step] digital inputs) |

The A4988 IC is designed to operate standard bipolar stepper motors in full, half, quarter, eighth, and sixteenth-step modes.

Two camera control relays connect two contacts to a common third contact to command a connected digital camera to take a photograph. The microcontroller activates each relay using digital output pins connected to the relay coils.

The display/keypad board is connected to one of the microcontroller's serial communication peripherals (inter-integrated circuit port). The microcontroller sends commands for display of characters on the LCD and to read the state of the keypad switches. The LCD provides two rows of 16 characters for displaying/modifying system settings, activating motor movements and camera control sequences, and displaying the progress of an active shooting sequence.

We claim the following attributes for the subject invention:

1) An apparatus and method to automatically obtain images in incremental focal-distance steps using any of three possible methods, all involving use of a stepper motor to drive a lead screw and platform in controlled steps while taking a photograph at each step, or while continuously recording a video.

2) method of claim 1 wherever a controller provides the means to energize the stepper motor manually, or is able to program the motor functions and trigger the camera sequentially, and which allows setting the following parameters; motor speed, number of steps, angular change per step, and delay time between steps,—or instead allows continuous video filming during the sequential focus changes.

3) The method of claim 1 in which the focus change is achieved by controlled rotation of the focus ring using a lead screw rotated by the stepper motor.

4) The method of claim 3 using a Z-shaped support structure wherein the camera/lens are mounted on the top of platform and the motor/leadscrew/rail mechanism on its base, by which the motor driven screw causes horizontal movement of a plate mounted on a moving platform confined to a rail which in turn, through magnetic coupling, moves a rigid tab extending down from the focus ring, thereby rotating the ring.

5) The method of claim 3 in which the camera/lens is mounted above and on the end of a commercial stepper motor/linear rail/lead-screw device in such a way that by extending the lead screw out beyond the end, a pulley gear can be attached to it and by then adding a gear band to the focus ring, a pulley-gear-band can couple the drive gear below to the focus ring above, allowing the stepper motor to control rotation of the focus ring.

6) method of claim 1 whereby the focal distance is changed simply by moving the camera/lens together, such that the images are sequentially taken in focal steps from the very front to the very back of the subject.

7) method of claim 6 whereby the camera/lens is mounted on a moving platform, being caused to move horizontally on a linear rail by means of a stepper motor/lead screw coupled directly to the platform by means of a nut threaded onto the screw but restricted from rotation by being attached to the moving platform, which is itself confined to a rail.

8) The method of claim 1 in which the camera and the lens are connected via a bellows and the two elements are connected independently to the apparatus structure.

9) The method of claim 8 whereby the lens is attached to the rigid support structure and the camera is mounted on a platform which in turn, is mounted on a linear rail and caused to move horizontally by means of the stepper motor/lead screw through a threaded nut on the lead screw but which is restrained from rotation by being attached to the platform thereby allowing images to be sequentially taken in focal steps from the very front to the very back of the subject.

10) method of claim 8, whereby the camera is attached to the rigid support structure and the lens is mounted on a platform which in turn, is mounted on a linear rail and caused to move horizontally by means of the stepper motor/lead screw through a threaded nut on the lead screw but which is restrained from rotation by being attached to the platform thereby allowing images to be sequentially taken in focal steps from the very front to the very back of the subject.

11) method in claim 1 whereby the images are obtained by video recording while the focal distance is simultaneously changed stepwise, using controller settings in terms of speed and step size optimized to match the video frame rate of capture, such as for claim 3, Method 1—covering 20 degree rotation in 20 seconds, thereby capturing 140 frames with a 7 frame per second video camera speed and adjusting the delay time between steps to deliver optimum clarity in individual frames.
